(19) United States
(12) Patent Application Publication
(10) Pub. No.: US 2013/0095815 A1
(43) Pub. Date: Apr. 18, 2013

(54) PACKET GATEWAY INTEGRATED WITH CONTENT MANAGEMENT FOR 3G AND 4G MOBILE NETWORKS

(71) Applicants: Srinivasan Venkatraman, Belmont, MA (US); Anand Krishnamurthy, Acton, MA (US); Hassan Ahmed, Andover, MA (US); Paul Sherer, Danville, CA (US)

(72) Inventors: Srinivasan Venkatraman, Belmont, MA (US); Anand Krishnamurthy, Acton, MA (US); Hassan Ahmed, Andover, MA (US); Paul Sherer, Danville, CA (US)

(21) Appl. No.: 13/273,523

(22) Filed: Oct. 14, 2011

(51) Int. Cl. H04W 4/00

(52) U.S. Cl. 455/422.1

(57) ABSTRACT

Methods and apparatus, including computer program products, for a packet gateway integrated with content management for 3G and 4G mobile networks. A network server includes a processor, a memory, a packet gateway module integrated with a content management module, the content management module including mobile subscriber information, and communication links to one or more of a mobile network operator's Online Charging System (OCS), an Offline Charging Subsystem (OFCS) and Policy Control and Charging Function (PCRF).

### BACKGROUND OF THE INVENTION

The present invention pertains to wireless networks, and more particularly to a packet gateway integrated with content management for 3G and 4G mobile networks.

Packet gateways are switching systems that provide mobile termination call processing for circuit (e.g., time-division multiplexed) connections and packet (e.g., Internet Protocol—IP) connections. Packet gateways are sometimes referred to as gateway mobile switching centers (MSCs). Packet gateways are typically not connected to cell sites or base stations. Packet gateways are often used to coordinate telecommunications services for a service provider that has networks of different technologies. For example, a service provider arranges its networks such that all calls are directed to a packet gateway, rather than to a MSC for a particular technology. Because packet gateways are capable of communicating with MSCs and home location registers (HLRs) of multiple technologies, the packet gateway is effective in directing calls to the appropriate MSC and associated HLR, if necessary.

### SUMMARY OF THE INVENTION

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

The present invention provides methods and apparatus, including computer program products, for a packet gateway integrated with content management for 3G and 4G mobile networks.

In an aspect, the invention features a network server including a processor, a memory, a packet gateway module integrated with a content management module, the content management module including mobile subscriber information, and communication links to one or more of a mobile network operator's Online Charging System (OCS), an Offline Charging Subsystem (OFCS) and Policy Control and Charging Function (PCRF).

In another aspect, the invention features a network server including a processor, a memory, a packet data network (PDN) gateway (PGW) module integrated with a content management module, the content management module including mobile subscriber information, and communication links to one or more of a mobile network operator's Online Charging System (OCS), an Offline Charging Subsystem (OFCS) and Policy Control and Charging Function (PCRF).

In another aspect, the invention features a network server including a processor, a memory, a gateway general packet radio service (GPRS) support node (GGSN) module integrated with a content management module, the content management module including mobile subscriber information, and communication links to one or more of a mobile network operator's Online Charging System (OCS), an Offline Charging Subsystem (OFCS) and Policy Control and Charging Function (PCRF).

Other features and advantages of the invention are apparent from the following description, and from the claims.

### BRIEF DESCRIPTION OF THE DRAWINGS

The invention will be more fully understood by reference to the detailed description, in conjunction with the following figures, wherein:

FIG. 1 is a block diagram of an exemplary mobile network.

FIG. 2 is a block diagram of an exemplary network server.

### DETAILED DESCRIPTION

The subject innovation is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

As used in this application, the terms “component,” “system,” “platform,” and the like can refer to a computer-related entity or an entity related to an operational machine with one or more specific functionalities. The entities disclosed herein can be either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

Moreover, terms like “user equipment,” “mobile station,” “mobile,” “subscriber station,” “communication device,” “access terminal,” “terminal,” “handset,” and similar terminology, refer to a wireless device (e.g., cellular phone, smart phone, computer, personal digital assistant (PDA), set-top box, Internet Protocol Television (IPTV), electronic gaming device, printer, tablet, Wi-Fi Hotspot and so forth) utilized by a subscriber or user of a wireless communication service to receive or convey data, control, voice, video, sound, gaming, or substantially any data-stream or signaling-stream. The foregoing terms are utilized interchangeably in the subject specification and related drawings. Likewise, the terms “access point,” “base station,” “Node B,” “evolved Node B,” “home Node B (HNB),” and the like, are utilized interchangeably in the subject application, and refer to a wireless network component or appliance that serves and receives data, control, voice, video, sound, gaming, or substantially any data-stream or signaling-stream from a set of subscriber stations. Data and signaling streams can be packetized or frame-based flows.

Furthermore, the terms “user,” “subscriber,” “customer,” and the like are employed interchangeably throughout the subject specification, unless context warrants particular distinction(s) among the terms.

Content management (e.g., proxy, caching, content manipulation) for wireless networks is typically done behind the Gi interface in a mobile 3G/4G network. The Gi interface is an Internet Protocol (IP) based interface between a Gateway General Packet Radio Service (GPRS) Support Node (GGSN) and a public data network (PDN) either directly to the Internet or through a Wireless Access Point (WAP) gateway. Solutions in existing wireless operator networks, such as AT&T and Verizon, suffer from a significant drawback, i.e., content management and subscriber management are done in different nodes in the network and have little interaction. This leads to inefficiencies and lack of flexibility in controlling a user Quality of Experience (QoE). The present invention addresses these drawbacks by integrating content management with the PDN Gateway (4G) or GGSN (3G).

The drawbacks of existing non-integrated network include a lack of subscriber knowledge outside the Packet Gateway (PGW/GGSN), a lack of the ability to configure packet treatment based on subscriber behavior, and a lack of a feedback mechanism.

Regarding the lack of subscriber knowledge outside the Packet Gateway (PGW/GGSN), operators typically implement solutions where the subscriber ID (e.g., IMEI) is embedded into the packet (e.g., HTTP header) and the content management node fetches the subscriber information through the standard interfaces (e.g., PCRF/AAA/Radius). This is an additional query that leads to latency and inefficiency.

Regarding the lack of the ability to configure packet treatment based on subscriber behavior, a non-integrated solution doesn't dynamically adapt a treatment of packet flows based on analytics collected for a subscriber.

Regarding the lack of a feedback mechanism, a non-integrated solution does not provide any feedback to the gateway function and does not allow the gateway to take additional actions (e.g., traffic management).

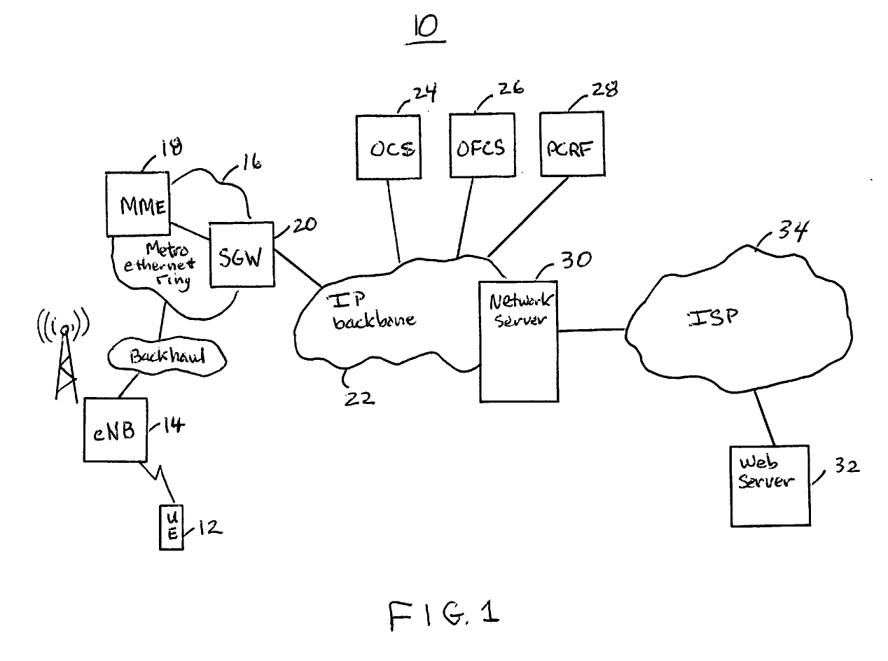

As shown in FIG. 1, a mobile network 10 includes user equipment (UE) 12, such as a smart phone. Other examples of US 12 include, but are not limited to, cellular phone, computer, personal digital assistant (PDA), set-top box, Internet Protocol Television (IPTV), electronic gaming device, printer, tablet, Wi-Fi Hotspot and so forth. The UE 12 is wirelessly linked to an Evolved Node B (eNB) 14. The eNB 14 is a radio part of a cell site. A single eNB may contain several radio transmitters, receivers, control sections and power supplies. The eNB 14 is backhauled to a metro ethernet ring 16, which includes a Mobility Management Entity (MME) 18 and a Serving Gateway (SGW) 20. Backhaul is a process of transferring packets or communication signals over relatively long distances to a separate location for processing. The SGW 20 routes and forwards user data packets, while also acting as the mobility anchor for a user plane during inter-eNodeB handovers.

The SGW 20 is linked to an Internet Protocol (IP) backbone 22. The IP backbone 22 includes links to a Online Charging System (OCS) 24, an Offline Charging Subsystem (OFCS) 26 and a Policy Control and Charging Function (PCRF) 28. In general, the OCS 24 is a set of interconnected network elements that enable the identification, rating and posting of charges in real time (or near real time). The OFCS 26 receives charging data in the form of Call Detail Records (CDRs) and Diameter accounting messages from network elements after the subscriber incurs network resource usage.

The IP backbone 22 includes a network server 30 that implements a packet gateway integrated with content management for 3G and 4G mobile networks. The network server 30 is linked to a web server 32 through an Internet Service Provider (ISP) 34.

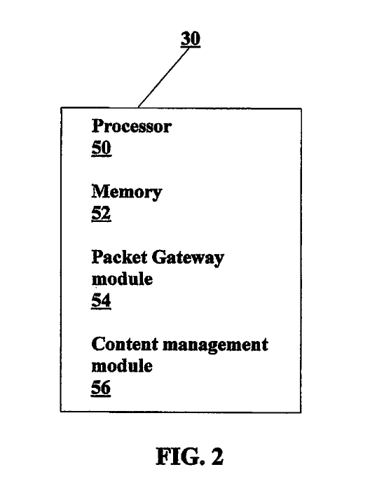

As shown in FIG. 2, the network server 30 includes a processor 50, memory 52, PDN Gateway (PGW) module 54 and content management module 56. The PGW module 54 is a gateway used in LTE/4G networks that provides connectivity from the UE 12 to external packet data networks (PDNs) by being a point of exit and entry of traffic for the UE 12. The content management module 56 is a content management system (CMS) capable of storing and delivering content and services to UE 12, such as mobile phones, smart phones, and PDAs. Integration of the PGW module 54 and content management module 56 enables an integrated subscriber management and content management function. In particular, mobile subscriber information is readily available along with numerous content management functions included in the content management module 56, such as content filtering, content caching, content adaptation, analytics, content optimization, and so forth.

For example, traditionally, when a user on UE 12 requests a broadcast application, such as a sporting event, from the web server 32, the application knows nothing about the subscriber and the subscriber knows nothing about the application. Using the network server 30, integration of the PGW module 54 and content management module 56 enable a higher Quality of Service (QoS) because subscriber information, such as a form factor of the UE 12, is known, as well as charging information from the OCS 24, the OFCS 26 and the PCRF 28, and thus delivery of the content from the web server 32 can be adapted and or customized to the specific UE 12.

The configuration of the network server 30 described above is suitable for a 4G network yet may be adapted to other network types. For example, in 2G, 3G and WCDMA mobile networks, the PGW module 54 is replaced with a Gateway GPRS Support Node (GGSN) module. In such an adaptation, the GGSN module is responsible for the interworking between a General Packet Radio Service (GPRS) network and external packet switched networks, like the Internet and X.25 networks.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback), and input from the user can be received in any form, including acoustic, speech, or tactile input.

The systems and techniques described here can be implemented in a computing system that includes a back-end component (e.g., a data server), or that includes a middleware component (e.g., an application server), or that includes a front-end component (e.g., a client computer having a graphical user interface or a web browser through which a user can interact with an implementation of the systems and techniques described here), or any combination of such back-end, middleware, or front-end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

The foregoing description does not represent an exhaustive list of all possible implementations consistent with this disclosure or of all possible variations of the implementations described. A number of implementations have been described. Nevertheless, it will be understood that various modifications may be made without departing from the spirit and scope of the systems, devices, methods and techniques described here. For example, various forms of the flows shown above may be used, with steps re-ordered, added, or removed. Accordingly, other implementations are within the scope of the following claims.

What is claimed is:

1. A network server comprising:
a processor;
a memory;
a packet gateway module integrated with a content management module, the content management module including mobile subscriber information, the mobile subscriber information derived from mobile subscriber information stored and maintained by a mobile network provider and comprising at least owner information, subscriber device information and subscriber mobile charging and subscription plan information; and
communication links to one or more of a mobile network operator's Online Charging System (OCS), an Offline Charging Subsystem (OFCS) and Policy Control and Charging Function (PCRF).

2. The network server of claim 1 wherein the packet gateway module is a PGW module used in LTE/4G networks that provides connectivity from mobile user equipment to external packet data networks (PDNs) by being a point of exit and entry of traffic for the mobile user equipment.

3. The network server of claim 1 wherein the packet gateway module is a gateway general packet radio service (GPRS) support node (GGSN) module responsible for interworking between a GPRS network and external packet switched networks such as the Internet and X.25 networks.

4. The network server of claim 1 wherein the content management module comprises functions for storing and delivering content and services to mobile user equipment.

5. The network server of claim 4 wherein the mobile user equipment is selected from the group consisting of mobile phones, smart phones, and personal data assistants (PDAs).

6. The network server of claim 4 wherein the content management module further comprises a content filtering module, a content caching module, a content adaptation module, an analytics module and a content optimization module.

7. The network server of claim 1 wherein the content management module receives input from the OCS, the OFCS and the PCRF.

8. A network server comprising:
a processor;
a memory;
a packet data network (PDN) gateway (PGW) module integrated with a content management module, the content management module including mobile subscriber information, the mobile subscriber information derived from mobile subscriber information stored and maintained by a mobile network provider and comprising at least owner information, subscriber device information and subscriber mobile charging and subscription plan information; and
communication links to one or more of a mobile network operator's Online Charging System (OCS), an Offline Charging Subsystem (OFCS) and Policy Control and Charging Function (PCRF).

9. The network server of claim 8 wherein the PGW module is a gateway used in LTE/4G networks that provides connectivity from mobile user equipment to external packet data networks (PDNs) by being a point of exit and entry of traffic for the mobile user equipment.

10. The network server of claim 8 wherein the content management module comprises functions for storing and delivering content and services to mobile user equipment.

11. The network server of claim 10 wherein the mobile user equipment is selected from the group consisting of mobile phones, smart phones, and personal data assistants (PDAs).

12. The network server of claim 10 wherein the content management module further comprises a content filtering module, a content caching module, a content adaptation module, an analytics module and a content optimization module.

13. The network server of claim 8 wherein the content management module receives input from the OCS, the OFCS and the PCRF.

14. A network server comprising:
a processor;
a memory;
a gateway general packet radio service (GPRS) support node (GGSN) module integrated with a content management module, the content management module including mobile subscriber information, the mobile subscriber information derived from mobile subscriber information stored and maintained by a mobile network provider and comprising at least owner information, subscriber device information and subscriber mobile charging and subscription plan information; and
communication links to one or more of a mobile network operator's Online Charging System (OCS), an Offline Charging Subsystem (OFCS) and Policy Control and Charging Function (PCRF).

15. The network server of claim 14 wherein the GGSN module is responsible for interworking between a GPRS network and external packet switched networks such as the Internet and X.25 networks.

16. The network server of claim 14 wherein the content management module comprises functions for storing and delivering content and services to mobile user equipment.

17. The network server of claim 16 wherein the mobile user equipment is selected from the group consisting of mobile phones, smart phones, and personal data assistants (PDAs).

18. The network server of claim 16 wherein the content management module further comprises a content filtering module, a content caching module, a content adaptation module, an analytics module and a content optimization module.

19. The network server of claim 14 wherein the content management module receives input from the OCS, the OFCS and the PCRF.
